(19) United States
(12) Patent Application Publication
(10) Pub. No.: US 2026/0240388 A1
(43) Pub. Date: Aug. 20, 2026

(54) DUST-COLLECTOR SUCTION NOZZLE AND ROTATING-TOOL DUST COLLECTION TOOL INCLUDING THE SAME

(71) Applicant: COBALTECH Co., Ltd., Sapporo-shi (JP)

(72) Inventor: Masanobu TAKEMATA, Sapporo-shi (JP)

(21) Appl. No.: 19/536,744

(22) Filed: Feb. 11, 2026

(30) Foreign Application Priority Data
Feb. 18, 2025 (JP) 2025-023914

(51) Int. Cl. A47L 9/02; A47L 9/14; A47L 9/16; B23B 49/00; B23Q 11/00

(52) U.S. Cl. CPC A47L 9/02; A47L 9/14; A47L 9/1625; A47L 9/1666; A47L 9/1683; A47L 9/1691; B23B 49/006; B23Q 11/0046

(57) ABSTRACT

A dust-collector suction nozzle for a rotating-tool dust collection tool attached to a rotating tool including a core drill collects cutting chips. The nozzle includes a nozzle body rotatably and axially supported by a bearing member, a drill coupling portion at a front end, and a rotating-tool coupling portion at a rear end. At least one suction passage extends from a front end surface through the nozzle body, and a plurality of communication holes extend from an outer circumferential surface to communicate with the suction passage. The communication holes are arrayed along a circumferential direction, with opening positions alternately displaced back and forth in an axial direction.

### BACKGROUND OF THE INVENTION

### Field of the Invention

The present invention relates to a dust-collector suction nozzle that is attached to a rotating tool including a core drill and that collects cutting chips, and a rotating-tool dust collection tool that includes the same.

### Description of the Related Art

A core drill is a cylindrical drill having a front end that is opened, and is used for perforating concrete or the like. At the front end of the core drill, a concave-convex blade is formed, and on the surface of the blade, abrasive grains having a high hardness degree, such as diamond powder, are fixed. A hard substance such as concrete is scraped away by the blade and the hard abrasive grains little by little, and thereby can be perforated.

Further, there is a problem in that the perforation of a hard object such as concrete generates heat due to the friction at the time of cutting, carbonizes diamond used as the abrasive grains, decreases the hardness degree, and significantly decreases the cutting ability. Hence, in the conventional perforation of the diamond abrasive grains with the core drill, the work is generally performed while cooling is performed by spraying water or the like.

However, at some work places, water or the like cannot be used. In addition, there is concern about the environmental pollution caused by the drainage of water containing cutting chips.

In response to such problems, in Japanese Utility Model No. 3218922, the applicant of the present application proposed a cutting tool with a dust collection function, and has acquired the utility model right (Japanese Utility Model No. 3218922). The cutting tool includes a core drill that has a cylindrical shape and that includes a cutting blade at one end, a center member that extends along a central axis of the core drill in a longer direction of the core drill, and a nozzle body that couples the core drill and a rotating tool. The nozzle body has an insertion hole into which the center member is inserted, and includes a connection portion that is connected with the core drill, a plurality of first holes that is formed on the connection portion, and a suction passage into which cutting chips produced by the cutting with the cutting blade are sucked through the plurality of first holes.

The cutting tool with the dust collection function collects cutting chips while performing the perforation work. Therefore, cutting chips do not remain in a hole opened by the perforation, or the like, so that it is possible to restrain the generation of heat due to the friction with cutting chips. Further, when the air at the time of the suction of cutting chips passes through the front end of the core drill, cooling is performed together with the dust collection. Therefore, the cutting tool with the dust collection function has a beneficial function effect in that cooing water is unnecessary and environmental pollution can be prevented because cutting chips are collected by a dust collector.

In recent years, the above function effect has been attracting attention, and the cutting tool with the dust collection function described in Japanese Utility Model No. 3218922, in addition to the perforation of concrete, has started to be applied to the perforation of external walls for air-conditioner installation or the like and the specimen sampling in asbestos inspections that are executed in advance, for example, in the case where an architectural structure is to be demolished.

However, in the perforation of the external wall, the target to be perforated is not limited to only an external wall material, and it is necessary to perforate a plurality of layers constituted by different architectural materials such as heat insulation materials, wood including structural plywood, plaster boards, and wallpaper. In the case where a single member such as concrete is perforated, the size of the produced cutting chips and the gap between the core drill and the object at the time of perforation are roughly constant, and as the suction performance for sucking cutting chips and the cooling performance of the air that passes through the gap, performances expected in the design can be exerted. In the case where different architectural materials are perforated, there is a concern that the size of the produced cutting chips and the gap with the core drill may vary and the suction performance and the cooling performance cannot be sufficiently obtained depending on architectural materials.

Further, in the specimen sampling in the asbestos inspection, a higher dust collection performance is required than in the perforation of concrete, because it is necessary to surely prevent cutting chips from being scattered at the time of sampling.

Consequently, for the application to the perforation of an external wall composed of a plurality of materials and the specimen sampling in the asbestos inspection, the required suction power and dust collection power are higher than ever.

Meanwhile, the core drill performs the perforation by rotating while being pressed against the object, and therefore, the nozzle body coupling the rotating tool and the core drill receives a high torque (torsion power). Therefore, there is also a problem in that it is necessary to avoid the strength of the nozzle body from being decreased for the improvement in suction power.

The present invention has been made for solving the above problems, and has an object to provide a dust-collector suction nozzle and a rotating-tool dust collection tool including the same that make it possible to achieve both the improvement in suction power and the strength.

### SUMMARY OF THE INVENTION

For solving the problem about the achievement of both the improvement in suction power and the restraint in strength decrease, a dust-collector suction nozzle according to the present invention is a dust-collector suction nozzle configured to be used in a rotating-tool dust collection tool that is attached to a rotating tool including a core drill and that collects cutting chips, in which: the dust-collector suction nozzle includes a nozzle body that is axially supported in a rotatable manner by a bearing member of the rotating-tool dust collection tool, a drill coupling portion for coupling the core drill to a front end of the nozzle body, and a rotating-tool coupling portion for coupling the rotating tool to a rear end of the nozzle body; and in the nozzle body, at least one or more suction passages that extend from a front end surface on a side of the drill coupling portion and that pass through an interior of the nozzle body and a plurality of communication holes that extends from an outer circumferential surface of the nozzle body and that communicates with the suction passage are formed, and the communication holes are disposed such that the communication holes are arrayed along a circumferential direction of the nozzle body and opening positions of the communication holes are displaced alternately back and forth in an axial direction of the nozzle body.

Further, for solving the problem about the achievement of both the improvement in suction power and the restraint in strength decrease, a rotating-tool dust collection tool according to the present invention is a rotating-tool dust collection tool including the dust-collector suction nozzle and the bearing member that supports the dust-collector suction nozzle in a rotatable manner, in which the bearing member includes a dust collection hole that is connectable to a dust collector having a suction function and that communicates with the communication holes of the dust-collector suction nozzle that rotates.

According to the present invention, it is possible to achieve both the improvement in dust collection power and the restraint in strength decrease.

### BRIEF DESCRIPTION OF THE DRAWINGS

FIG. 1 is a front view showing an embodiment of a rotating-tool dust collection tool according to the present invention;

FIG. 2 is a sectional view showing the rotating-tool dust collection tool in the embodiment;

FIG. 3 is a perspective view showing a dust-collector suction nozzle in the embodiment;

FIG. 4 is a side view of a drill coupling portion side showing the dust-collector suction nozzle in the embodiment;

FIGS. 5(a) and 5(b) are schematic views about the distance between adjacent coupling holes, and FIG. 5(a) shows a case where opening positions of communication holes are disposed on a line and FIG. 5(b) shows a case where opening positions of communication holes are displaced alternately back and forth;

FIG. 6 is a partially-sectional front view showing the use state at the time of the perforation with the rotating-tool dust collection tool in the embodiment; and

FIG. 7 is a sectional view showing another embodiment of the rotating-tool dust collection tool according to the present invention.

### DETAILED DESCRIPTION OF THE INVENTION

An embodiment of a rotating-tool dust collection tool according to the present invention will be described below with use of the drawings.

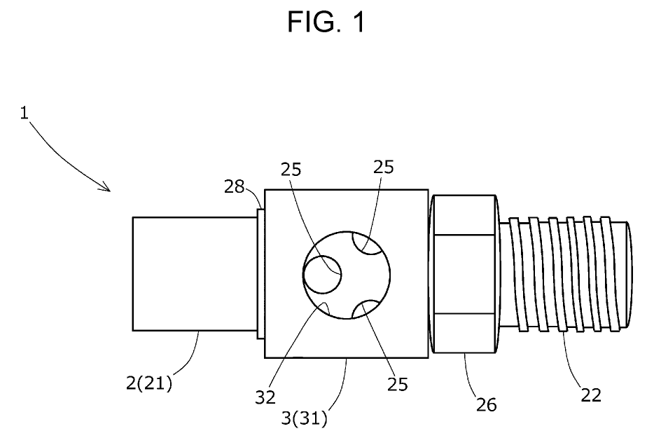

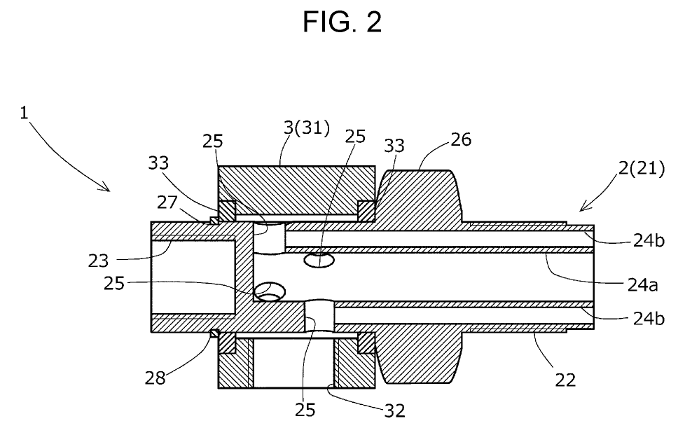

As shown in FIG. 1 and FIG. 2, a rotating-tool dust collection tool 1 in the embodiment includes a dust-collector suction nozzle 2 for sucking cutting chips g and a bearing member 3 that axially supports the dust-collector suction nozzle 2 in a rotatable manner. Each constituent will be described below in detail.

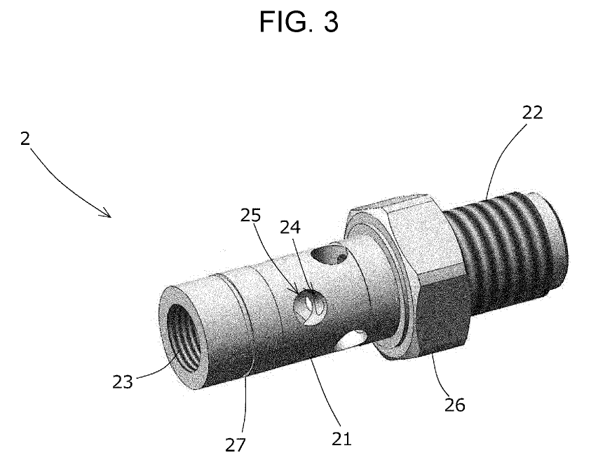

The dust-collector suction nozzle 2 is a nozzle for sucking cutting chips g that are produced when a wall W or the like is cut by a core drill 4, and is a member for transmitting the rotational power by the rotating tool 5 to the core drill 4. As shown in FIG. 2 and FIG. 3, the dust-collector suction nozzle 2 in the embodiment includes a nozzle body 21, a drill coupling portion 22 at a front end of the nozzle body 21, a rotating-tool coupling portion 23 at a rear end of the nozzle body 21, a suction passage 24 that passes from a front end surface on the side of the drill coupling portion 22, communication holes 25 that extend from an outer circumferential surface of the nozzle body 21 and that communicates with the suction passage 24, a support convex portion 26 that is attached to the outer circumferential surface of the nozzle body 21 and that supports the bearing member 3, and a snap-ring groove 27 for providing a snap ring that supports the bearing member 3 together with the support convex portion 26.

The nozzle body 21 is a member that is formed in a roughly columnar shape, and is formed of stainless steel, in the embodiment. The material of the nozzle body 21 is not limited to stainless steel, and may be appropriately selected from metal materials having necessary strengths, and the like.

The drill coupling portion 22 is a portion for coupling the core drill 4 to the front end side of the nozzle body 21, and is formed in a shape corresponding to a base end portion 41 of the core drill 4. The drill coupling portion 22 in the embodiment is constituted by a screw thread formed in a male screw shape on the outer circumferential surface of the front end side of the nozzle body 21, so as to be capable of being screwed into a female screw of the base end portion 41 of the core drill 4.

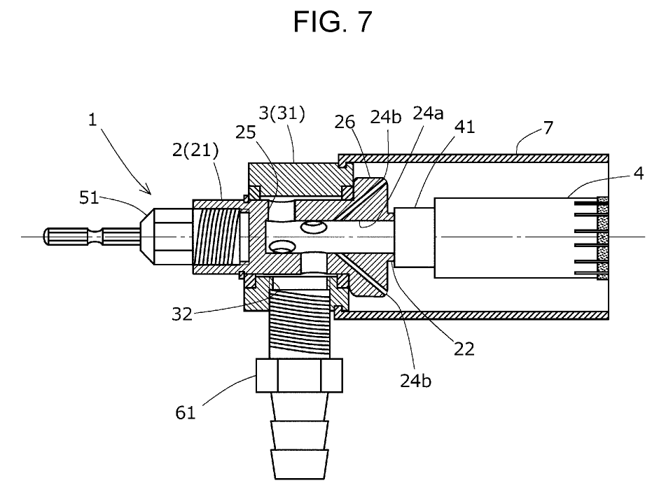

The outer diameter of the drill coupling portion 22 is selected depending on the size of the core drill 4 that is coupled, and the like. As shown in FIG. 7, in the case where the core drill 4 having a relatively small size is coupled, the drill coupling portion 22 may be formed so as to have a smaller diameter than the nozzle body 21.

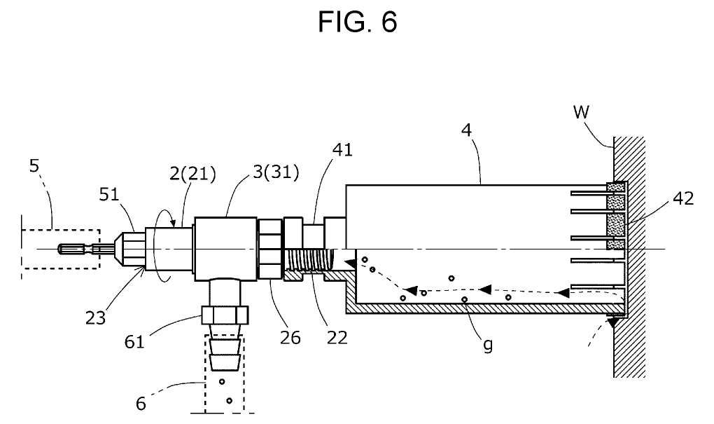

The rotating-tool coupling portion 23 is a portion for coupling the rotating tool 5 to the rear end side of the nozzle body 21, and is formed in a shape corresponding to the rotating tool 5 that is coupled, or a coupling tool for coupling the rotating tool 5. The rotating-tool coupling portion 23 in the embodiment is constituted by a female screw formed on a rear end surface of the nozzle body 21, and as shown in FIG. 6, a drill chuck 51 is screwed as a coupling tool.

The rotating-tool coupling portion 23 is not limited to the constitution with the female screw, and may be formed in a shape allowing the rotating tool 5 to be directly coupled, for example, in the same shape as the drill chuck 51.

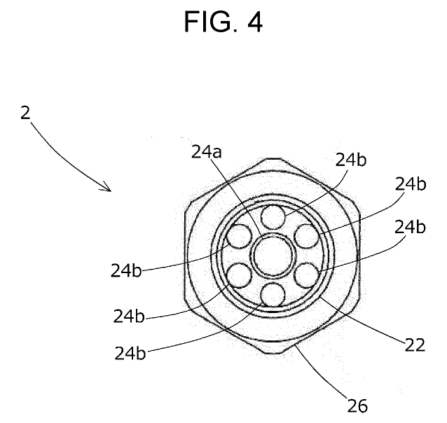

The suction passage 24 is a passage for sucking, from the interior of the core drill 4, cutting chips g produced by cutting the wall W or the like, and is constituted by at least one or more passages that extend from the front end surface of the nozzle body 21 on the side of the drill coupling portion 22 and that pass through the interior of the nozzle body 21. In the embodiment, as shown in FIG. 2 and FIG. 4, there are a first suction passage 24a formed so as to have a relatively larger diameter and six second suction passages 24b opened at the periphery of the first suction passage 24a.

As shown in FIG. 2, the first suction passage 24a in the embodiment passes from the front end surface on the side of the drill coupling portion 22 to the vicinity of the rotating-tool coupling portion 23 along the central axis.

Further, the second suction passage 24b is has a smaller diameter than the first suction passage 24a, and is formed parallel to the first suction passage 24a, so as to reach a depth allowing the communication with the communication hole 25.

In the suction passage 24, the sizes and number of holes are not particularly limited, and may be appropriately selected based on an expected size and amount of cutting chips g, and the like. Further, as shown in FIG. 7, the suction passage 24 may extend from not only the front end surface of the nozzle body 21 but also a front end surface of the support convex portion 26, and may pass through the interior of the nozzle body 21.

The communication hole 25 is a hole for discharging, to the outside, cutting chips g sucked into the interior of the nozzle body 21 through the suction passage 24, and passes from the outer circumferential surface of the nozzle body 21 to the suction passage 24. In the embodiment, a plurality of communication holes 25 is formed for increasing the opening area and thereby restraining the pressure loss of air to enhance the suction performance. Specifically, six communication holes 25 are formed, and one communication hole 25 communicates with one second suction passage 24b.

Further, in the embodiment, for restraining the decrease in strength while increasing the opening area using the plurality of communication holes 25 as described above, the communication holes 25 are disposed such that the communication holes 25 are arrayed along the circumferential direction of the nozzle body 21 and the opening positions are displaced alternately back and forth in the axial direction.

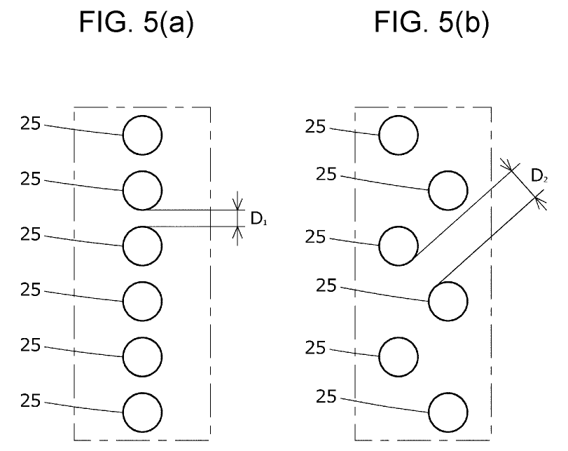

That is, as shown in FIGS. 5(a) and 5(b), in the comparison between a case where the communication holes 25 are disposed so as to be arrayed on a line in the circumferential direction and a case where the communication holes 25 having the same size are disposed such that the opening positions are displaced alternately back and forth, the opening area is the same between both cases. However, in the case where the communication holes 25 are disposed such that the opening positions are displaced alternately back and forth, an interval D₂ between adjacent communication holes 25 is wider than an interval D₁ between adjacent communication holes 25 in the case where the communication holes 25 are disposed so as to be arrayed on a line, and the sectional area between holes are larger. Consequently, in the case where the communication holes 25 are disposed such that the opening positions are displaced alternately back and forth, the strength of the nozzle body 21 is higher, so that it is possible to restrain the decrease in strength due to the increase in opening area.

The number and size of communication holes 25, the distance by which the communication holes 25 are displaced alternately back and forth, and the like are not particularly limited, and may be appropriately selected depending on a necessary opening area and a necessary strength.

The support convex portion 26 is a projection for supporting the front end side of the bearing member 3 when the bearing member 3 is attached to the nozzle body 21, and is formed so as to project to the outside of the outer circumferential surface of the nozzle body 21, on the front end side of the nozzle body 21 from the opening positions of the communication holes 25. As shown in FIG. 3 and FIG. 4, the support convex portion 26 in the embodiment is formed such that the section has a roughly hexagonal shape, and is formed so as to be capable of being grasped by a spanner such that the nozzle body 21 does not rotate together when the core drill 4 is attached to or detached from the drill coupling portion 22 while being rotated.

The shape of the support convex portion 26 is not limited to the hexagonal shape, and may be appropriately selected from shapes that facilitates the grasp when the core drill 4 is attached and that allows the support of the bearing member 3.

The snap-ring groove 27 is a groove for mounting the snap ring that supports the rear end side of the attached bearing member 3, and is formed in a concave groove shape on the outer circumferential surface of the nozzle body 21, on the rear end side from the positions where the communication holes 25 are opened. As shown in FIG. 6, in the snap-ring groove 27 in the embodiment, a commercially available C-shaped snap ring 28 is fit.

The snap ring installed in the snap-ring groove 27 is not limited to the C-shaped snap ring 28, and may be appropriately selected from snap rings having various shapes, as exemplified by an R-shaped snap ring, an S-shaped snap ring, and a bevel-type snap ring.

Next, the bearing member 3 will be described. The bearing member 3 is a member for supporting the dust-collector suction nozzle 2 in a rotatable manner and allowing a dust collector 6 to collect cutting ships g that are discharged from the dust-collector suction nozzle 2.

As shown in FIG. 1 and FIG. 2, the bearing member 3 in the embodiment includes a bearing body 31 formed in a cylindrical shape, a dust collection hole 32 formed on the bearing body 31, and bearings 33 allowing the dust-collector suction nozzle 2 to smoothly rotate.

The bearing body 31 is formed in a cylindrical shape, and is formed of stainless steel similarly to the nozzle body 21, in the embodiment. The inner diameter of the bearing body 31 is formed so as to be slightly larger than the outer diameter of the nozzle body 21.

The dust collection hole 32 is a hole for communicating with the communication holes 25 of the dust-collector suction nozzle 2 that rotates and causing cutting chips g to pass to the dust collector 6 that is connected. As shown in FIG. 1, the dust collection hole 32 in the embodiment is formed so as to have such a size that the whole of the rotating communication holes 25 can be seen as viewed from the opening side of the dust collection hole 32 (such a size that the diameter is a length from the front edge of a communication hole 25 disposed on the front side to the rear edge of a communication hole 25 disposed on the rear side).

Further, the dust collection hole 32 in the embodiment has a female screw formed on an inner circumferential surface, and a joint 61 for the connection to the dust collector 6 can be mounted. The dust collector 6 that is connected to the dust collection hole 32 is a machine having a suction function, and a commercially available vacuum cleaner or the like can be used.

The bearing 33 is a member for smoothly rotating the dust-collector suction nozzle 2, and is a ball bearing or the like. As shown in FIG. 2, the bearing 33 in the embodiment is installed on each of the front end side and rear end side of the bearing body 31.

The bearing member 3 is installed by being fit to the dust-collector suction nozzle 2 from the rear end side so as to make contact with the support convex portion 26, such that the C-shaped snap ring 28 is fit in the snap-ring groove 27 of the dust-collector suction nozzle 2. At this time, a gap through which relatively small cutting chips g can pass is formed between the inner circumferential surface of the bearing member 3 and the outer circumferential surface of the dust-collector suction nozzle 2.

Next, the operation of each constituent of the rotating-tool dust collection tool 1 in the embodiment will be described.

As preparation, as shown in FIG. 6, the core drill 4 is coupled to the drill coupling portion 22 of the dust-collector suction nozzle 2. Since the support convex portion 26 in the embodiment is formed such that the section shape is a roughly hexagonal shape, and the grasp by the spanner is easy, and it is possible to prevent the dust-collector suction nozzle 2 from rotating together when core drill 4 is screwed.

Further, the drill chuck 51 is screwed into the female screw of the rotating-tool coupling portion 23, and the rotating tool 5 such as an impact driver is coupled through the drill chuck 51.

Furthermore, the joint 61 is screwed into the dust collection hole 32 of the bearing member 3, and a hose of the dust collector 6 is coupled to the joint 61 by connection or the like.

In the case where the wall W or the like is perforated, the rotating tool 5 is actuated, and the front end of the core drill 4 is pressed against the wall W while the core drill 4 is rotated. The core drill 4 scrapes away and perforates the wall W with a blade 42 at the front end.

The dust collector 6, by suction power, collects cutting chips g scraped away by the core drill 4. At this time, as shown in FIG. 6, the air sucked by the dust collector 6 passes through the front end of the core drill 4 from the periphery of a hole opened by the perforation, flows to the interior of the drill, and is sucked from the suction passage 24 of the dust-collector suction nozzle 2 to the dust collector 6 through the communication holes 25 and the dust collection hole 32 of the bearing member 3. Along this air flow, cutting chips g produced by the cutting are collected by the dust collector 6.

At this time, relatively small cutting chips g are constantly collected from the communication holes 25 because of the gap between the inner circumferential surface of the bearing member 3 and the outer circumferential surface of the dust-collector suction nozzle 2, and relatively large cutting chips g are discharged and collected from the communication holes 25 when the rotating communication holes 25 and the dust collection hole 32 overlap with each other.

On the nozzle body 21 in the embodiment, the plurality of communication holes 25 is opened, and the whole opening area of the communication holes 25 is widely formed. Therefore, the pressure loss when the dust collector 6 sucks air is small, and a high suction power is obtained.

Consequently, even if a plurality of layers constituted by different architectural materials, as exemplified by an external wall of a building, is perforated and the size of the produced cutting chip g and the gap between the core drill 4 and the hole at the time of the perforation are not constant, a high suction performance can be exerted and a stable dust collection ability can be exerted. Further, in the specimen sampling in an asbestos inspection, it is possible to prevent cutting chips g from being scattered around the periphery, and therefore, it is possible to safely perform the sampling work.

Further, cutting chips g in the gap between the core drill 4 and the hole opened by the perforation are quickly removed, and therefore, the generation of friction heat can be restrained. Further, the amount of the air that passes through the gap between the core drill 4 and the hole increases, and therefore, the ability to cool the front end of the core drill 4 that is heated by friction heat improves.

Consequently, it is possible to prevent the carbonization of abrasive grains such as diamond powder that are fixed to the surface of the core drill 4, and it is possible to maintain a high perforation performance.

Furthermore, the communication holes 25 in the embodiment are disposed such that the positions are displaced in the axial direction, and therefore, the interval between adjacent communication holes 25 is widely formed. Consequently, even if a high torque is applied to the dust-collector suction nozzle 2 when a hard object such as concrete is perforated, the work can be safely performed without folding and bending.

The above-described rotating-tool dust collection tool 1 and dust-collector suction nozzle 2 in the embodiment can exhibit the following effects.
1. By disposing the plurality of communication holes 25 such that the positions are displaced in the axial direction, the whole opening area can be increased, the suction power can be improved, and a high strength can be maintained because the interval D₂ between holes is widened.
2. Because of the improvement in suction power, it is possible to restrain the generation of friction heat at the time of perforation by quickly removing cutting chips g, it is possible to enhance the cooling effect by increasing the amount of the passing air, and it is possible to maintain the cutting ability by restraining the carbonization of diamond powder.
3. Even if a plurality of layers constituted by different architectural materials, as exemplified by an external wall of a building, is perforated and thereby the size of the produced cutting chip g and the gap between the core drill 4 and the hole at the time of the perforation are not constant, a high suction performance can be exerted and a stable dust collection ability can be exerted.
4. In the specimen sampling in the asbestos inspection, it is possible to prevent cutting chips g from being scattered around the periphery, and therefore, it is possible to safely perform the sampling work.

The rotating-tool dust collection tool and dust-collector suction nozzle according to the present invention are not limited to the above-described embodiment, and can be appropriately altered. For example, for surely preventing the scattering of cutting chips g in the specimen sampling in the asbestos inspection, a scattering prevention cover 7 that can extend and contract in the axial direction may be installed at the periphery of the core drill 4, as shown in FIG. 7.

### REFERENCE SIGNS LIST

1 rotating-tool dust collection tool
2 dust-collector suction nozzle
3 bearing member
4 core drill
5 rotating tool
6 dust collector
7 scattering prevention cover
W wall
g cutting chip
21 nozzle body
22 drill coupling portion
23 rotating-tool coupling portion
24 suction passage
25 communication hole
26 support convex portion
27 snap-ring groove
28 C-shaped snap ring
31 bearing body
32 dust collection hole
33 bearing
41 base end portion
42 blade
51 drill chuck
61 joint

1. A dust-collector suction nozzle configured to be used in a rotating-tool dust collection tool that is attached to a rotating tool including a core drill and that collects cutting chips, wherein:
the dust-collector suction nozzle comprises a nozzle body that is axially supported in a rotatable manner by a bearing member of the rotating-tool dust collection tool, a drill coupling portion for coupling the core drill to a front end of the nozzle body, and a rotating-tool coupling portion for coupling the rotating tool to a rear end of the nozzle body; and
in the nozzle body, at least one or more suction passages that extend from a front end surface on a side of the drill coupling portion and that pass through an interior of the nozzle body and a plurality of communication holes that extends from an outer circumferential surface of the nozzle body and that communicates with the suction passage are formed, and the communication holes are disposed such that the communication holes are arrayed along a circumferential direction of the nozzle body and opening positions of the communication holes are displaced alternately back and forth in an axial direction of the nozzle body.

2. A rotating-tool dust collection tool comprising the dust-collector suction nozzle according to claim 1 and the bearing member that supports the dust-collector suction nozzle in a rotatable manner, wherein
the bearing member includes a dust collection hole that is connectable to a dust collector having a suction function and that communicates with the communication holes of the dust-collector suction nozzle that rotates.
